(19) United States
(12) Patent Application Publication
(10) Pub. No.: US 2010/0295478 A1
(43) Pub. Date: Nov. 25, 2010

(54) LED DRIVING CIRCUIT

(75) Inventors: Tian Yi WEI, Shanghai (CN); Shrek WANG, Shanghai (CN); Andrew JIANG, Shanghai (CN); Hai Bo QIAO, Shanghai (CN); Wilhelmus CORNELISSEN, Eindhoven (NL); Jack JIANG, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/706,007

(22) Filed: Feb. 16, 2010

(30) Foreign Application Priority Data
May 25, 2009 (CN) 200910141650.7

(51) Int. Cl. H05B 41/36

(52) U.S. Cl. 315/307

(57) ABSTRACT

The present invention provides a LED driving circuit, which is adapted to be coupled to a power supply via a phase control dimmer. The driving circuit comprises a power switch unit and a control unit, wherein the control unit comprises a first signal sampling module, a frequency converting module, a feedback module and a PWM module, the first signal sampling module being configured to sample a first signal and to provide the first signal to the frequency converting module; the frequency converting module being configured to generate a second signal in response to the first signal and to provide the second signal to the PWM module; and the feedback module being configured to sample a third signal and to provide the third signal to the PWM module; the PWM module being configured to generate a fourth signal in response to the second signal and the third signal, so as to control the output current of the power switch unit, the frequency of the fourth signal being determined by the second signal and the duty cycle of the fourth signal being determined by the third signal.

### FIELD OF THE INVENTION

The present invention relates to a LED (light-emitting diode) driving circuit, especially to a dimmable LED driving circuit.

### BACKGROUND OF THE INVENTION

LED lamps are gradually taking the place of conventional incandescent lamps and Halogen lamps and have become an emerging light source because of the high emission efficiency, low power consumption and long lifetime.

At present, most commercially available phase control dimmers, e.g. leading edge dimmers and trailing edge dimmers, are merely configured to connect to real resistance loads, e.g. incandescent lamps and Halogen lamps. Annoying phenomena, such as flicker and unstable luminance variation, should be prevented when an LED lamp connects with conventional phase control dimmers, because the LED lamp is not a real resistance load.

### SUMMARY OF THE INVENTION

The present invention provides a LED driving circuit, which is capable of being adapted to a phase control dimmer, such as a leading edge dimmer or a trailing edge dimmer.

According to an embodiment of the invention, there is provided a LED driving circuit, which is coupled to a power supply via a phase control dimmer, said driving circuit comprising a power switch unit and a control unit, wherein the control unit comprises a first signal sampling module, a frequency converting module, a feedback module and a pulse width modulation (PWM) module, the first signal sampling module being configured to sample a first signal, which signal represents phase modulation information of electric power provided by the power supply when the electric power is modulated by the dimmer, and to provide the first signal to the frequency converting module; the frequency converting module being configured to generate a second signal in response to the first signal and to provide the second signal to the PWM module, the frequency of the second signal depending on the average signal intensity of the first signal; the feedback module being configured to sample a third signal, which signal represents the output current of the power switch unit, and to provide the third signal to the PWM module; the PWM module being configured to generate a fourth signal in response to the second signal and the third signal, so as to control the output current of the power switch unit, the frequency of the fourth signal being determined by the second signal and the duty cycle of the fourth signal being determined by the third signal.

Optionally, the control unit further comprises a signal processing module, configured to receive the first signal sampled by the first signal sampling module and to execute anti-jamming processing on the first signal, and to provide the processed first signal to the frequency converting module.

Since anti jamming processing is executed on the first signal, it is more convenient to sample the signal and interfering signal contained in the sampled signal could be filtered, and a more appropriate signal is available for subsequent modules.

Optionally, the control unit further comprises a slope compensation module, configured to receive the first signal sampled by the first signal sampling module and to execute slope compensation on the first signal, and to provide the compensated first signal to the frequency converting module, wherein the slope compensation executed by the slope compensation module when an average signal intensity of the first signal smaller than a first threshold is larger than the slope compensation when the average signal intensity of the first signal larger than the first threshold.

It is beneficial to achieve a continuously smooth dimming effect, which is obtained in that slope compensation is executed on the first signal, since the sensitivity of the first signal could be modified.

According to an embodiment of the present invention, the driving circuit further comprises a current compensation unit which comprises a second signal sampling module, a latching current compensation module, a holding current compensation module and a logic control module, wherein the second signal sampling module is configured to sample a fifth signal and a sixth signal, which both represent the phase modulation information of the electric power provided by the power supply when the electric power is modulated by the dimmer, and to provide the fifth signal to the latching current compensation module, and to provide the sixth signal to the holding current compensation module; the latching current compensation module being configured to operate when the fifth signal is below a second threshold, so as to provide a compensated latching current to the dimmer; the holding current compensation module being configured to operate when the sixth signal is below a third threshold, so as to provide a compensated holding current to the dimmer; the logic control module being configured to control the holding current compensation module to be idle when the latching current compensation module is in operation, or to control the latching current compensation module to be idle when the holding current compensation module is in operation.

According to another embodiment of the present invention, the driving circuit comprises a rectifier unit and a impedance unit, wherein the impedance unit is located between the rectifier unit and the power supply and comprises at least one set of impedance elements, whose impedance is more than 30 ohm.

The impedance unit could effectively reduce an inrush current arising in the circuit, which helps to achieve a stable dimming performance.

According to another embodiment of the present invention, the driving circuit further comprises a rectifier unit and an electromagnetic interference filtering unit, wherein the electromagnetic interference filtering unit comprises a first set of capacitors which are coupled to the output terminals of the rectifier unit.

A stable dimming performance is enhanced in that the electromagnetic interference filtering unit can effectively reduce electromagnetic interference, and moreover, space is saved because fewer components are used.

The driving circuits provided by the embodiments of the present invention are applicable to phase control dimmers, such as leading edge dimmers and trailing edge dimmers. Optionally, the driving circuits of some embodiments of the present invention could overcome defects, such as flickering and unstable luminance variation, during the dimming process, so as to achieve a relatively desirable dimming effect.

### BRIEF DESCRIPTION OF THE DRAWINGS

Other features, objects and advantages of the present invention will be more apparent by reference to the following detailed description of non-limited exemplary embodiments, when taken in conjunction with the accompanying drawings:

FIG. 1 illustrates a circuit module of the driving circuit according to an embodiment of the present invention;

FIG. 2 illustrates a circuit module of the control unit of the driving circuit according to an embodiment of the present invention;

FIG. 3 illustrates a circuit structure of the first signal sampling module according to an embodiment of the control unit as illustrated in FIG. 2;

FIG. 4 illustrates a circuit structure of the frequency converting module according to an embodiment of the control unit as illustrated in FIG. 2;

FIG. 5 illustrates a circuit structure of the frequency converting module according to another embodiment of the control unit as illustrated in FIG. 2;

FIG. 6 illustrates a circuit module of the power switch unit according to an embodiment of the driving circuit as illustrated in FIG. 1;

FIG. 7 illustrates a circuit module of the current compensation unit of the driving circuit according to another embodiment of the present invention;

FIG. 8 illustrates a circuit structure of the current compensation unit of the driving circuit according to another embodiment of the present invention;

FIG. 9 illustrates a circuit structure of the impedance unit of the driving circuit according to a further embodiment of the present invention;

FIG. 10 illustrates a circuit structure of the electromagnetic interference filtering unit of the driving circuit according to another embodiment of the present invention;

Same or similar reference signs represent same or similar apparatuses or modules or features.

### DESCRIPTION OF EMBODIMENTS

Descriptions of embodiments of the present invention are given in detail herein below, in conjunction with the accompanying drawings.

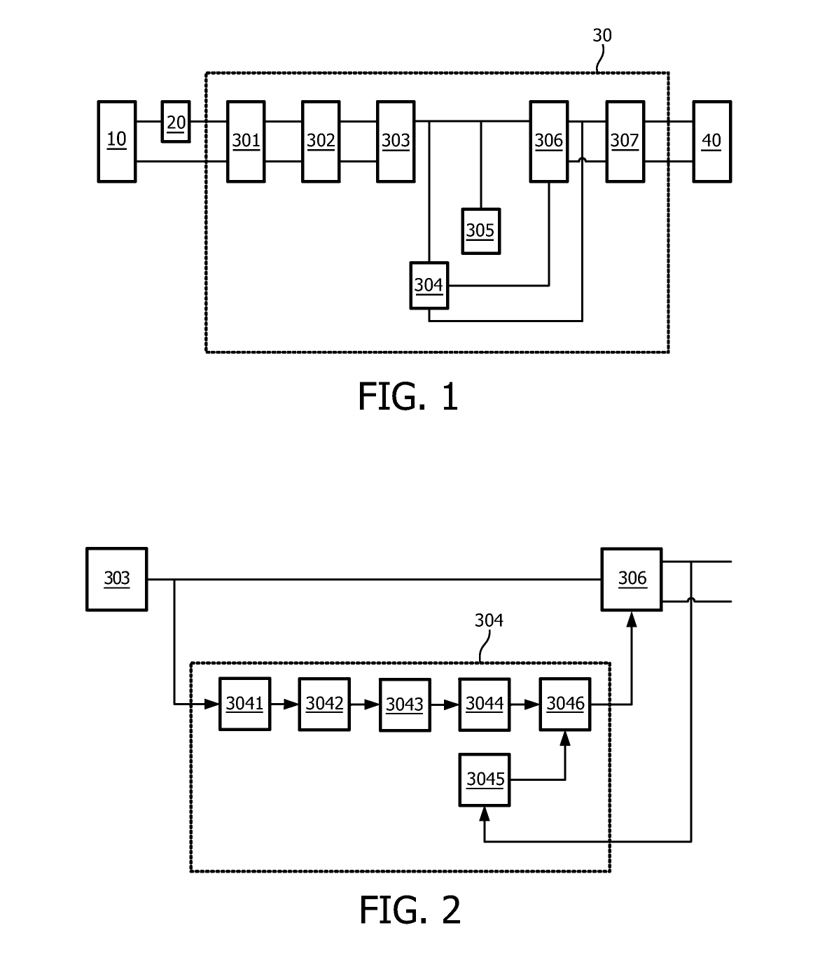

FIG. 1 illustrates a circuit module of the LED driving circuit according to an embodiment of the present invention. Without loss of generality, the driving circuit 30 as illustrated in FIG. 1 is coupled to the power supply 10 via the dimmer 20, so as to provide appropriate electric power to the LED 40. As illustrated in the Figure, the dashed rectangle represents the driving circuit 30, which comprises an impedance unit 301, an electromagnetic interference filtering unit 302, a rectifier unit 303, a control unit 304, a current compensation unit 305, a power switch unit 306 and a rectifier and filtering unit 307.

Optionally, the driving circuit 30 could further comprise a filtering unit (not illustrated in FIG. 1) subsequent to the rectifier unit 303. This filtering unit is configured to filter the signal rectified by the rectifier unit 303, so as to generate a smoother signal, which will be understood by those skilled in the art, and therefore will not be described in more detail.

Commonly, the power supply 10 provides mains power, whose voltage varies according to country.

The dimmer 20 is a phase control dimmer, in particular, but not limited to, is a leading edge dimmer or a trailing edge dimmer.

The LED 40 is either a LED or one or more LED arrays consisting of a plurality of LEDs arranged in series/parallel.

The impedance unit 301 in the driving circuit 30 is configured to reduce the inrush current arising in the circuit. The electromagnetic interference filtering unit 302 is configured to reduce electromagnetic interference in the circuit.

The current compensation unit 305 is configured to supply a compensated current (referred as “the compensated latching current” and “the compensated holding current” hereinafter, respectively) to the latching current and/or holding current for the dimmer 20, respectively. It is known to those skilled in the art that a leading edge dimmer controls the average output voltage by means of controlling the lead angle of a SCR (Silicon Controlled Rectifier). An appropriate latching current for a SCR is needed to trigger the SCR. If there are spikes in the latching current for a SCR, the SCR might be repeatedly in On-Off status, so that the LED 40 might flicker. Therefore, the current compensation unit 305 provides the compensated latching current to trigger the SCR. When the SCR is switched on, the current flowing across the SCR needs to remain above a certain holding current, so that the SCR remains switched on. During the On-state of the SCR, the current flowing across the SCR will continuously decrease; when the current flowing across the SCR decreases till the SCR can't remain switched on, the current compensation unit 305 will provide the compensated holding current, so that the SCR won't be switched off until the end of the half-cycle of the sine wave.

The control unit 304 is configured to sample the first signal rectified by the rectifier unit 303 and to generate a second signal as well as a fourth signal in response to the second signal and the third signal sampled from the output terminal of the power switch unit 306, to control the output current of the power switch unit 306, so that control on the luminance brightness of the LED 40 is achieved. The first signal represents the phase modulation information of the electric power provided by the power supply 10 when the electric power is modulated by the dimmer 20. The frequency of the second signal is determined by the average signal intensity of the first signal. The third signal represents the output current of the power switch unit 306. The frequency of the fourth signal is determined by the second signal and the duty cycle of the fourth signal is determined by the third signal.

When the dimmer 20 is adjusted, the frequency of the fourth signal generated by the control unit 304 varies. When the dimmer 20 is adjusted to brighten the LED 40, the frequency of the fourth signal generated by the control unit 304 increases, so that the output current of the power switch unit 306 increases and the LED 40 is brightened accordingly. However, when the dimmer 20 is adjusted to dim the LED 40, the frequency of the fourth signal generated by the control unit 304 decreases, so that the output current of the power switch unit 306 decreases and the LED 40 dims.

It is to be noted that, as illustrated in FIG. 1, the first signal has been rectified by the rectifier unit 303. However, it is apparent to those skilled in the art that, in another embodiment of the invention, the control unit 304 could directly sample the first signal from the output terminal of the dimmer 20.

It is also to be noted that the driving circuit 30 shown in FIG. 1 illustrates many preferable embodiments of some units. It will be understood by those skilled in the art that the impedance unit 301, the electromagnetic interference filtering unit 302, the current compensation unit 305 illustrated in FIG. 1 are optional.

Descriptions of the circuit structure of the above-mentioned circuit units are provided in detail hereinbelow, in conjunction with FIG. 2 to FIG. 10.

FIG. 2 illustrates circuit modules of the control unit 304 of the driving circuit according to an embodiment of the present invention. As illustrated in the Figure, the dashed rectangle represents the control unit 304. The control unit 304 comprises a first signal sampling module 3041, a signal processing module 3042, a slope compensation module 3043, a frequency converting module 3044, a feedback module 3045 and a PWM module 3046.

It is to be noted that circuit modules of many preferable embodiments of the invention are illustrated in the control unit 304 in FIG. 2. It will be understood by those skilled in the art that the signal processing module 3042 and the slope compensation module 3043 are optional circuit modules in the control unit 304.

As illustrated in FIG. 2, the first signal sampling module 3041 samples the first signal rectified by the rectifier unit 303, and provides the first signal to the signal processing module 3042.

The first signal represents phase modulation information of the electric power provided by the power supply 10 when the electric power is modulated by the dimmer 20.

It is to be noted that the first signal sampled by the first signal sampling module 3041 has been rectified by the rectifier unit 303 in this embodiment. However, the first signal sampling module 3041 could directly sample the first signal from the output terminal of the dimmer 20, which is apparent to to those skilled in the art.

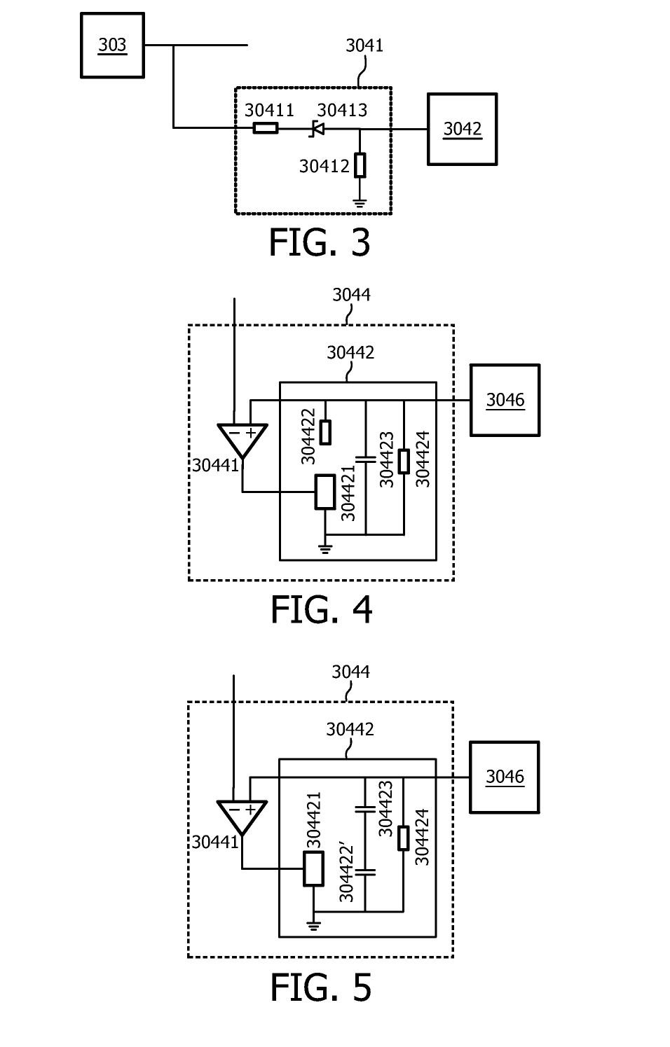

FIG. 3 illustrates the circuit structure of the first signal sampling module 3041 according to an embodiment of the control unit 304 as illustrated in FIG. 2. As illustrated in the Figure, the dashed rectangle represents the first signal sampling module 3041. The first signal sampling module 3041 comprises a first impedance element 30411, a second impedance element 30412 and a Zener diode 30413 connected in series.

The first impedance element 30411 is coupled to the rectifier unit 303 at one end and to the cathode of the Zener diode 30413 at the other end. The second impedance element 30412 is coupled to ground at one end and to the anode of the Zener diode 30413 at the other end. The first signal, which is rectified by the rectifier unit 303, is sampled from the anode of the Zener diode 30413.

It is to be noted that the connection mode among the first impedance element 30411, the second impedance element 30412 and the Zener diode 30413 is not limited as illustrated in FIG. 2. In another embodiment, the first impedance element 30411 and the Zener diode 30413 could be interchanged, and the first signal rectified by the rectifier unit 303 is sampled from the junction point between the first impedance element 30411 and the second impedance element 30412.

Optionally, the reverse breakdown voltage of the Zener diode 30413 can be set from 100V to 150V.

The dimming range of the leading edge dimmer and the trailing edge dimmer could be balanced and compromised by means of the Zener diode 30413 in the first signal sampling module 3041, so that the dimming performance of the two kinds of dimmer tends to be consistent and notable differences between the dimming performances of the two kinds of dimmer are reduced.

It is to be noted that the circuit structure of the first signal sampling module 3041 illustrated in FIG. 3 is an exemplary embodiment, which can be changed into many variation embodiments. For example, in a variation embodiment, the first signal sampling module 3041 could only comprise the first impedance element 30411 and the second impedance element 30412, and the first signal rectified by the rectifier unit 303 is sampled from the junction point between the first impedance element 30411 and the second impedance element 30412 and provided to the signal processing module 3042.

Optionally, the first impedance element 30411 and the second impedance element 30412 could either be made up of one resistor or a plurality of resistors.

The signal processing module 3042 receives the first signal sampled by the first signal sampling module 3041 and executes anti-jamming processing to the first signal and provides the processed first signal to the slope compensation module 3043.

Optionally, the anti-jamming processing executed by the signal processing module 3042 on the first signal comprises adding a direct current signal to the first signal.

The signal processing module 3042 could adopt existing techniques of signal superposition to add a direct current signal to the first signal, which should be understood by those skilled in the art, and hence is not explained in greater detail for the purpose of conciseness.

Since anti jamming processing is executed on the first signal sampled by the first signal sampling module 3041, it is more convenient to sample the signal and interference signals contained in the sampled signal could be filtered, and thus an appropriate signal would be provided to subsequent modules.

The slope compensation module 3043 receives the anti-jamming processed first signal and executes slope compensation on the first signal, and provides the compensated first signal to the frequency converting module 3044.

Here, the slope compensation provided by the slope compensation module 3043 when the average signal intensity of the first signal smaller than a first threshold is larger than the slope compensation when the average signal intensity of the first signal larger than the first threshold.

Optionally, the first threshold is less than 1V.

It is beneficial to achieve a continuously smooth dimming effect, which is obtained in that slope compensation is executed on the first signal, since the sensitivity of the first signal could be modified.

The frequency converting module 3044 generates a second signal in response to the first signal compensated by the slope compensation module 3043 and provides the second signal to the PWM module 3046.

The frequency of the second signal is determined by the average intensity of the first signal.

Optionally, the PWM module 3046 comprises an oscillator, whose output signal is adjustable in frequency. The frequency of the output signal of the oscillator varies with the frequency of the input signal provided to the input terminal of the oscillator. The second signal generated by the frequency converting module 3044 is fed to the PWM module 3046 at the input terminal of the oscillator.

FIG. 4 illustrates the circuit structure of the frequency converting module 3044 according to an embodiment of the control unit 304 as illustrated in FIG. 2. As illustrated in the Figure, the dashed rectangle represents the frequency converting module 3044. The frequency converting module 3044 comprises a first comparator 30441 and a RC network 30442. The output signal of the RC network 30442 is provided to the PWM module 3046 as the second signal.

The first input terminal of the first comparator 30441 receives the first signal compensated by the slope compensation module 3043, and the second input terminal of the first comparator 30441 receives the output signal of the RC network 30442. The first comparator 30441 adjusts the impedance and/or capacitance of the RC network 30442 in accordance with the comparison between the first signal and the output signal of the RC network 30442, so as to adjust the frequency of the second signal.

Optionally, the RC network 30442 illustrated in FIG. 4 comprises a first switching element 304421, a third impedance element 304422, a first capacitance element 304423 and a fourth impedance element 304424. Here, the series-wound third impedance element 304422 and the first switching element 304421 are connected in parallel with the first capacitance element 304423 and the fourth impedance element 304424.

The first comparator 30441 controls whether the third impedance element 304422 is coupled to the RC network by controlling the first switching element 304421 to be On or Off, so as to adjust the impedance of the RC network 30442.

For example, when the input signal provided to the second input terminal of the first comparator 30441 is larger than that provided to the first input terminal, i.e. the output signal of the RC network 30442 is larger than the first signal compensated by the slope compensation module 3043, the first comparator 30441 controls the first switching element 304421 to be On. When the first switching element 304421 is On, the third impedance element 304422 is coupled to the RC network 30442, so that the impedance of the RC network 30442 is changed. When the impedance of the RC network 30442 is changed, the charge-discharge cycle of the RC network 30442 is changed accordingly, so that the input signal provided to the second input terminal of the first comparator 30441 is changed.

When the input signal provided to the second input terminal of the first comparator 30441 is lower than that provided to the first input terminal, i.e. the output signal of the RC network 30442 is lower than the first signal compensated by the slope compensation module 3043, the first comparator 30441 controls the first switching element 304421 to be Off. When the first switching element 304421 is switched off, the third impedance element 304422 is isolated from the RC network 30442.

When the dimmer 20 is adjusted, the frequency converting module 3044 controls whether the third impedance element 304422 is coupled to the RC network 30442, so that the RC network 30442 outputs output signals of different frequencies to the PWM module 3046 as the second signal.

It is to be noted that a DC supply (not illustrated in FIG. 4) should be applied to the input terminal of the RC network 30442 for charging. Optionally, the voltage of the DC supply ranges from 2 v to 2.5V. When the RC network 30442 is almost fully charged, it starts discharging, the output signal of the RC network 30442 being provided to the second input terminal of the first comparator 30441.

It is also to be noted that the RC network 30442 illustrated in FIG. 4 is an exemplary embodiment. It should be understood by those skilled in the art that the RC network 30442 is not limited to the structure as illustrated in FIG. 4.

In another embodiment, as illustrated in FIG. 5, the RC network 30442 comprises a first switching element 304421, a second capacitance element 304422′, a first capacitance element 304423 and a fourth impedance element 203324. Here, the series-wound second capacitance element 304422′ and the first capacitance element 304423 are connected in parallel with the fourth impedance element 304424, and the first switching element 304421 is connected in parallel with the second capacitance element 304422′.

The first comparator 30441 controls whether the second capacitance element 304422′ is coupled to the RC network or not by means of controlling the first switching element 304421 to be On or Off, so as to adjust the impedance of the RC network 30442.

Optionally, the first capacitance element 304423 and the second capacitance element 304422′ could either be made up of one capacitor or a plurality of capacitors, respectively. The third impedance element 304422 and the fourth impedance element 304424 could either be made up of one resistor or a plurality of resistors.

Moreover, the first switching element 304421 comprises but is not limited to a MOS transistor.

The feedback module 3045 samples a third signal and provides the third signal to the PWM module 3046. Herein, the third signal represents the output current of the power switch unit 306.

Optionally, the third signal could also be the output voltage or the output power of the power switch unit 306.

The PWM module 3046 generates a fourth signal in response to the second signal provided by the frequency converting module 3044 and the third signal provided by the feedback module 3045, so as to control the output current of the power switch unit 306.

The frequency of the fourth signal is determined by the second signal and the duty cycle of the fourth signal is determined by the third signal.

It is to be noted that, optionally, the PWM module 3046 could adopt a PWM converter chip in an existing LED driving circuit.

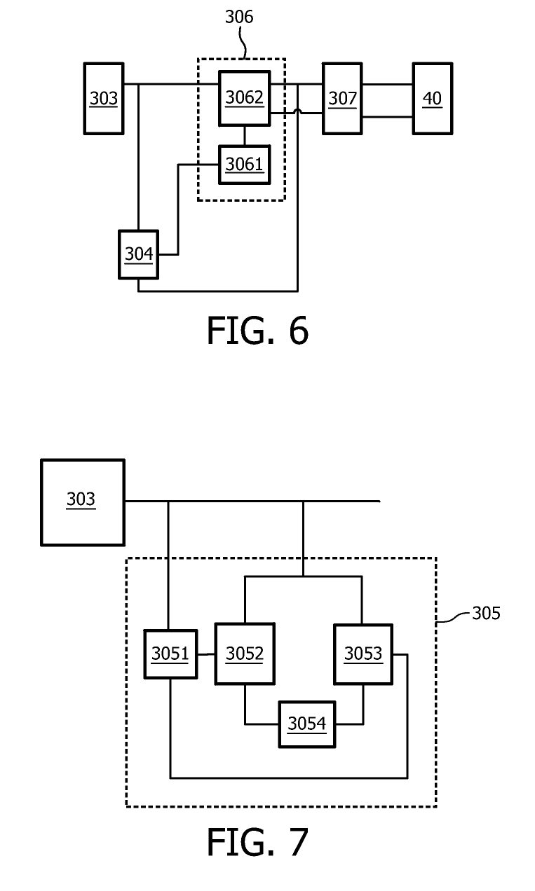

Optionally, as illustrated by the dashed rectangle in FIG. 6, the power switch unit 306 comprises a power switching element 3061 and a transformer 3062. Without loss of generality, the transformer 3062 comprises a primary winding and a secondary winding. The power switching element 3061 comprises but is not limited to a MOS transistor.

The fourth signal generated by the PWM module 3046 controls the power switching element 3061 to be On or Off, so that the primary winding of the transformer 3062 stores energy. The energy stored in the primary winding is coupled to the secondary winding, and then rectified and filtered by the rectifier and filtering circuit 307, and then supplied to the LED 40.

Optionally, the fourth signal generated by the PWM module 3046 is a square wave signal, whose frequency varies with the frequency of the second signal. Generally, while the frequency of the second signal rises, the frequency of the fourth signal generated by the PWM module 3046 also rises.

The frequency of the fourth signal generated by the PWM module 3046 varies when the dimmer 20 is adjusted, so that the on time and off time of the power switching element 3061 are changed, respectively. While the frequency of the fourth signal rises, the Off time of the power switching element 3061 will become shorter, so that the energy stored in the primary winding of the transformer 3062 increases. As the energy stored in the primary winding of the transformer 3062 increases, the energy coupled to the secondary winding and provided to the LED 40 will also increase, so that the LED 40 is brightened. However, as the frequency of the fourth signal decreases, the Off time of the power switching element 3061 will become longer, so that the energy stored in the primary winding of the transformer 3062 decreases. As the energy stored in the primary winding of the transformer 3062 decreases, the energy coupled to the secondary winding and provided to the LED 40 will also decrease, so that the LED 40 is dimmed.

The duty cycle of the fourth signal generated by the PWM module 3046 is determined by the third signal provided by the feedback module 3045.

If a user adjusts the dimmer 20 to perform a dimming operation, then, in response to the dimming operation, the control unit 304 outputs a corresponding fourth signal to control the output current of the power switch unit 306, so as to adjust the LED 40 to be brightened or dimmed. When the luminance brightness of the LED 40 is adjusted, the feedback module 3045 will sample the output current of the power switch unit 306 and feed it to the PWM module 3046, in order to ensure that the luminance brightness of the LED 40 maintains stable. If the output current of the power switch unit 306 sampled by the feedback module 3045 increases, the PWM module 3046 will reduce the duty cycle of the fourth signal and provide it to the power switch unit 306. If the output current of the power switch unit 306 sampled by the feedback module 3045 reduces, the PWM module 3046 will increase the duty cycle of the fourth signal and provide it to the power switch unit 306.

As those skilled in the art will understand the principle of how the PWM module 3046 adjusts the duty cycle of the fourth signal in response to the output current of the power switch unit 306 sampled by the feedback module 3045, a further detailed description will not be provided.

For the purpose of achieving a desirable dimming performance with the cooperation of the control unit 304, optionally, the driving circuit according to an embodiment of the present invention further comprises a current compensation unit 305.

FIG. 7 illustrates the current compensation unit 305 of the driving circuit according to another embodiment of the present invention. As illustrated in the Figure, the dashed rectangle represents the current compensation unit 305. The current compensation unit 305 comprises a second signal sampling module 3051, a latching current compensation module 3052, a holding current compensation module 3053 and a logic control module 3054.

As mentioned above, a leading edge dimmer controls the average output voltage by controlling the lead angle of a SCR. What is needed is an appropriate SCR latching current to trigger the SCR. If there are spikes in the latching current, the SCR might be repeatedly in On-Off status, so that the LED 40 might flicker. Therefore, the latching current compensation unit 3052 provides a compensated current to the latching current so as to trigger the SCR. When the SCR is switched on, the current flowing across the SCR needs to stay above a certain holding current, so that the SCR remains switched on. During the On period of the SCR, the current flowing across the SCR will continuously decrease; when the current flowing across the SCR decreases till the SCR can't remain switched on, the holding current compensation unit 3053 will provide a compensated current to the holding current, so that the SCR won't be switched off until the end of the half-cycle of the sine wave.

For example, the second signal sampling module 3051 samples a fifth signal and a sixth signal, which are both rectified by the rectifier unit 303, and provides the fifth signal to the latching current compensation module 3052, and provides the sixth signal to the holding current compensation module 3053.

Both the fifth signal and the sixth signal represent the phase modulation information of the electric power provided by the power supply 10 when the electric power is modulated by the dimmer 20.

The latching current compensation module 3052 determines whether the fifth signal is below a second threshold, and then, if the fifth signal is below the second threshold, the latching current compensation module 3052 starts operating so as to provide a compensated latching current (also referred as startup current) for the dimmer 20 to trigger the SCR in the dimmer 20.

The holding current compensation module 3053 determines whether the sixth signal is below a third threshold, and then, if the sixth signal is below the third threshold, the holding current compensation module 3053 starts operating so as to provide a compensated holding current for the dimmer 20, so that the SCR in the dimmer 20 won't be switched off until the end of the half-cycle of the sine wave.

The logic control module 3054 is configured to control the holding current compensation module 3053 to be idle while the latching current compensation module 3052 is in operation, or to control the latching current compensation module 3052 to be idle when the holding current compensation module is in operation.

Optionally, the second threshold is 54V, and the third threshold is 0.2V.

It is to be noted that the fifth signal and the sixth signal sampled by the second signal sampling module 3051 samples are rectified by the rectifier unit 303 in this embodiment. However, the second signal sampling module 3051 could directly sample the fifth signal and the sixth signal from the output terminal of the dimmer 20, which will be understood by those skilled in the art.

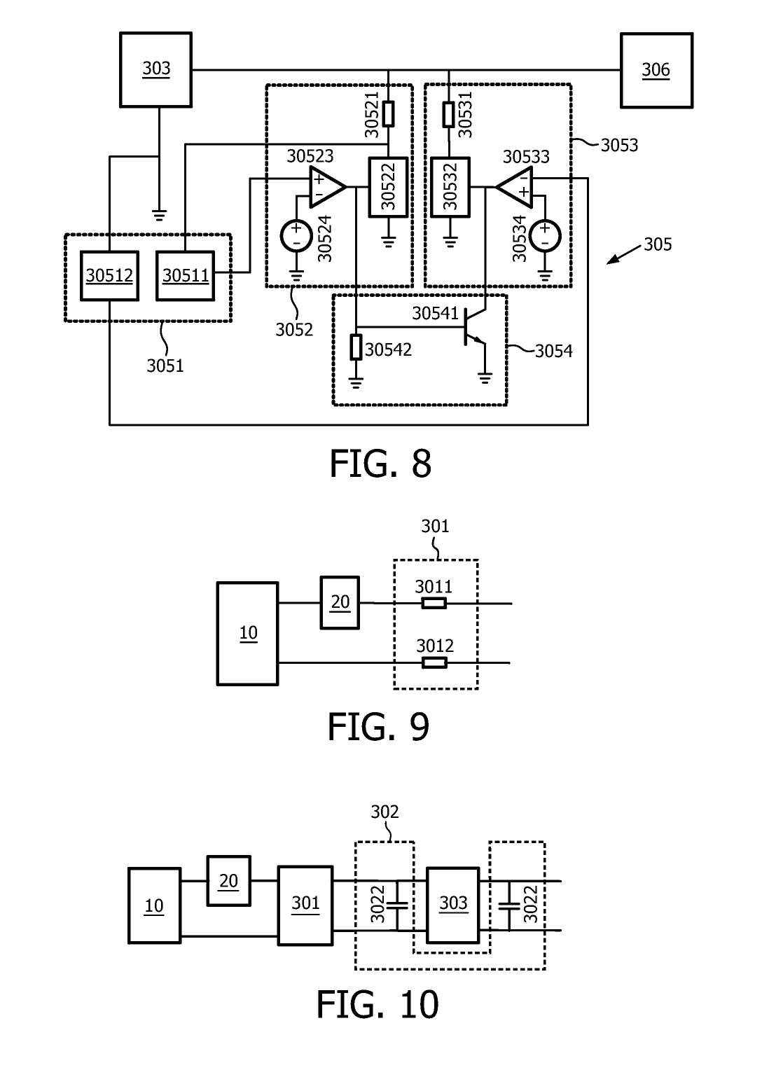

FIG. 8 illustrates the current compensation unit 305 of the driving circuit according to another embodiment of the present invention. As illustrated in the Figure, the four dashed rectangles represent respectively the second signal sampling module 3051, the latching current compensation module 3052, the holding current compensation module 3053 and the logic control module 3054.

The second signal sampling module 3051 comprises a first sub-sampling module 30511 and a second sub-sampling module 30512. Optionally, the first sub-sampling module 30511 and the second sub-sampling module 30512 could either be made up of one resistor or a plurality of resistors or only one piece of wire, respectively.

The latching current compensation module 3052 comprises a fifth impedance element 30521, a second switching element 30522, a second comparator 30523 and a first reference source 30524.

The fifth impedance element 30521 and the second switching element 30522 are connected in series between the first output terminal of the rectifier unit 303 and ground.

The first sub-sampling module 30511 samples the fifth signal rectified by the rectifier unit 303 from the junction point between the fifth impedance 30521 and the second switching element 30522, and provides the fifth signal to the first input terminal of the second comparator 30523. The first reference source 30524 provides the second threshold to the second input terminal of the second comparator 30523. The second comparator 30523 controls the second switch 30522 to be On or Off in accordance with the comparison between the fifth signal and the second threshold.

If the fifth signal is below the second threshold, the second comparator 30523 controls the second switching element 30522 to be On, so as to provide the compensated latching current for the dimmer 20.

The holding current compensation module 3053 comprises a sixth impedance element 30531, a third switching element 30532, a third comparator 30533 and a second reference source 30534.

The sixth impedance element 30531 and the third switching element 30532 are connected in series between the first output terminal of the rectifier unit 303 and ground.

The second sub-sampling module 30512 samples the sixth signal rectified by the rectifier unit 303 from the second output terminal of the rectifier unit 303, and provides the sixth signal to the first input terminal of the third comparator 30533. The second reference source 30534 provides the third threshold to the second input terminal of the third comparator 30533. The third comparator 30533 controls the third switch 30532 to be On or Off in accordance with the comparison between the sixth signal and the third threshold.

If the sixth signal is below the third threshold, the third comparator 30533 controls the third switching element 30532 to be On, so as to provide a compensated holding current for the dimmer 20.

The logic control module 3054 comprises a transistor 30541 and a seventh impedance element 30542. The base of the transistor 30541 is coupled to the output terminal of the second comparator 30523 and to ground via the seventh impedance element 30542. The collector of the transistor 30541 is coupled to the output terminal of the third comparator 30533. The emitter of the transistor is coupled to ground.

When the second comparator 30523 outputs a high level to control the second switching element 30522 to be On, the transistor 30541 is also switched on due to the high level applied to the base of the transistor 30541, so that the input terminal of the third switching element 30532 is pulled to a low level to control the third switching element 30532 to be Off. When the third comparator 30533 controls the third switching element 30532 to be On, the input terminal of the second switching element 30522 is pulled to a low level by the high level applied to the collector of the transistor 30541, so that the second switching element 30522 is controlled to be Off.

The second switching element 30522 and the third switching element 30532 comprise but are not limited to a MOS transistor, respectively.

It is to be noted that the connection mode of the transistor 30541 illustrated in FIG. 8 is an exemplary embodiment. It will be understood by those skilled in the art that, in another embodiment, the base of the transistor 30541 could be coupled to the output terminal of the third comparator 30533, and the collector is coupled to the output terminal of the second comparator 30523.

Moreover, the circuit structure of the logic control module 3054 illustrated in FIG. 8 is an exemplary embodiment. Any logic control module capable of controlling the holding current compensation module 3053 to be idle when the latching current compensation module 3052 is in operation, or capable of controlling the latching current compensation module 3052 to be idle when the holding current compensation module is in operation, will fall within the scope of protection of the present invention.

It is also to be noted that the second signal sampling module 3051 illustrated in FIG. 8 comprises two sub-sampling modules, which sample respectively the fifth signal and the sixth signal rectified by the rectifier unit 303 from different positions and provide respectively the fifth signal and the sixth signal to the latching current compensation module 3052 and the holding current compensation module 3053; however it will be understood by those skilled in the art that, in another embodiment, the second signal sampling module 3051 could also sample the fifth signal and the sixth signal rectified by the rectifier unit 303 from the same position and provide respectively the fifth signal and the sixth signal to the latching current compensation module 3052 and the holding current compensation module 3053. Optionally, the second signal sampling module 3051 could also sample the fifth signal and the sixth signal from other nodes, as long as these signals can reflect the working status of the dimmer 20. Optionally, the fifth signal and the sixth signal could be the same signal, or different signals.

In order to effectively reduce the inrush current arising in the circuit, optionally, the driving circuit according to an embodiment of the present invention further comprises an impedance unit 301.

FIG. 9 illustrates a circuit structure of the impedance unit 301 of the driving circuit according to a further embodiment of the present invention. As illustrated in the Figure, the dashed rectangle represents the impedance unit 301. The impedance unit 301 comprises a first impedance element set 3011 and a second impedance element set 3012.

The first impedance element set 3011 is coupled to the output terminal of the dimmer 20, and the input terminal of the dimmer 20 is coupled to the first output terminal of the power supply 10. The second impedance element set 3012 is coupled to the second output terminal of the power supply 10. Here, the impedances of the first impedance element set 3011 and the second impedance element set 3012 are both larger than 30 ohm.

It is to be noted that the impedance unit 301 illustrated in FIG. 9 comprises two sets of impedance elements. However, it will be understood by those skilled in the art that, in a variation embodiment, the impedance unit 301 could only comprise one set of impedance elements, whose impedance is larger than 30 ohm.

Optionally, the first impedance element set 3011 and the second impedance element set 3012 could each be made up of one resistor or a plurality of resistors.

For the purpose of security, optionally, at least one of the first impedance element set 3011 and the second impedance element set 3012 comprises a fuse resistor.

Moreover, since the first impedance element set 3011 and the second impedance element set 3012 may be possibly quickly destroyed under the continuous impact of the inrush current, optionally, the first impedance element set 3011 and the second impedance element set 3012 are both high-power resistors with a power rating of more than 0.5 W, in order to prolong the lifetime of the first impedance element set 3011 and the second impedance element set 3012.

In order to effectively reduce electromagnetic interference (EMI) in the circuit, optionally, the driving circuit according to an embodiment of the present invention further comprises an electromagnetic interference filtering unit 302.

FIG. 10 illustrates a circuit structure of the electromagnetic interference filtering unit 302 of the driving circuit according to another embodiment of the present invention. As illustrated in the Figure, the dashed part represents the electromagnetic interference filtering unit 302. The electromagnetic interference filtering unit 302 comprises a first capacitor set 3021 and a second capacitor set 3022.

The first capacitor set 3021 is coupled to the output terminal of the rectifier unit 303. The second capacitor set 3022 is coupled to the input terminal of the rectifier unit 303. Here, the capacitance of the second capacitor set 3022 is larger than that of the first capacitor set 3021.

It is to be noted that the second capacitor set 3022 is optional in the electromagnetic interference filtering unit 302. The second capacitor set 3022 forms the first filtering stage in the electromagnetic interference filtering unit 302, and the first capacitor set 3021 forms the second filtering stage in the electromagnetic interference filtering unit 302.

Optionally, the first capacitor set 3021 and the second capacitor set 3022 are both high-voltage capacitors with a voltage rating in excess of 400V.

Optionally, the first capacitor set 3021 and the second capacitor set 3022 could each be made up of one capacitor or a plurality of capacitors.

It is to be noted that the first filtering stage in the electromagnetic interference filtering unit 302 is not limited to the structure illustrated in FIG. 10. In a variation embodiment, the first filtering stage could also be replaced by other types of electromagnetic interference filtering structures, such as a II type filter or L type filter.

Above, embodiments of the present invention have been described in detail, but the present invention is not limited to these specific embodiments, and those skilled in the art can make various variations or modifications within the scope of the appended claims.

1. A LED driving circuit, which is adapted to be coupled to a power supply via a phase control dimmer, comprising a power switch unit and a control unit, the control unit comprising a first signal sampling module, a frequency converting module, a feedback module and a PWM module, wherein
the first signal sampling module is configured to sample a first signal, which signal represents phase modulation information of electric power provided by the power supply when the electric power is modulated by the dimmer, and to provide the first signal to the frequency converting module;
the frequency converting module is configured to generate a second signal in response to the first signal and to provide the second signal to the PWM module, the frequency of the second signal being determined by the average signal intensity of the first signal;
the feedback module is configured to sample a third signal, which signal represents the output current of the power switch unit, and to provide the third signal to the PWM module;
the PWM module is configured to generate a fourth signal in response to the second signal and the third signal, so as to control the output current of the power switch unit, the frequency of the fourth signal being determined by the second signal and the duty cycle of the fourth signal being determined by the third signal.

2. The driving circuit according to claim 1, wherein the control unit further comprises a signal processing module configured to receive the first signal sampled by the first signal sampling module and to execute an anti jamming processing on the first signal, and to provide the processed first signal to the frequency converting module.

3. The driving circuit according to claim 2, wherein the anti-jamming processing performed on the first signal comprises adding a direct current signal to the first signal.

4. The driving circuit according to claim 1, wherein the control unit further comprises a slope compensation module, configured to receive the first signal sampled by the first signal sampling module and to execute slope compensation on the first signal, and to provide the compensated first signal to the frequency converting module, wherein the slope compensation executed by the slope compensation module when an average signal intensity of the first signal smaller than a first threshold is larger than the slope compensation when the average signal intensity of the first signal larger than the first threshold.

5. The driving circuit according to claim 1, wherein the first signal sampling module comprises a first impedance element and a second impedance element connected in series, and the first signal is sampled from the joint between the first and the second impedance elements.

6. The driving circuit according to claim 5, wherein the first signal sampling module further comprises a Zener diode, which is connected in series with the first and the second impedance elements.

7. The driving circuit according to claim 1, wherein the frequency converting module comprises a RC network and a first comparator, wherein the first comparator adjusts impedance and/or capacitance of the RC network in accordance with a comparison between the first signal and an output signal of the RC network, so as to adjust the frequency of the second signal.

8. The driving circuit according to claim 7, wherein the RC network comprises a third impedance element and a first switching element, wherein the first comparator controls whether the third impedance element is coupled to the RC network or not by means of controlling whether the first switching element is in the On or Off state.

9. The driving circuit according to claim 1, wherein the driving circuit further comprises a current compensation unit which comprises a second signal sampling module, a latching current compensation module, a holding current compensation module and a logic control module, wherein
the second signal sampling module is configured to sample a fifth signal and a sixth signal, which both represent the phase modulation information of the electric power provided by the power supply when the electric power is modulated by the dimmer, and to provide the fifth signal to the latching current compensation module, and to provide the sixth signal to the holding current compensation module;
the latching current compensation module is configured to operate when the fifth signal is below a second threshold, so as to provide a compensated latching current for the dimmer;
the holding current compensation module is configured to operate when the sixth signal is below a third threshold, so as to provide a compensated holding current for the dimmer;
is the logic control module is configured to control the holding current compensation module so as to be idle when the latching current compensation module is in operation, and to control the latching current compensation module so as to be idle when the holding current compensation module is in operation.

10. The driving circuit according to claim 1, wherein the driving circuit comprises a rectifier unit and an impedance unit, wherein the impedance unit is located between the rectifier unit and the power supply and comprises at least one set of impedance elements whose impedance is more than 30 ohm.

11. The driving circuit according to claim 10, wherein the impedance unit comprises two sets of impedance elements, the two sets respectively coupling to different output terminals of the power supply.

12. The driving circuit according to claim 11, wherein at least one set of the two sets of impedance elements comprises a fuse resistor.

13. The driving circuit according to claim 1, wherein the driving circuit further comprises a rectifier unit and an electromagnetic interference filtering unit, wherein the electromagnetic interference filtering unit comprises a first set of capacitors which are coupled between output terminals of the rectifier unit.

14. The driving circuit according to claim 13, wherein the electromagnetic interference filtering unit further comprises a second set of capacitors, wherein the second set of capacitors are coupled between input terminals of the rectifier unit and the capacitance of the second set of capacitors is larger than that of the first set of capacitors.
